(19) United States
(12) Patent Application Publication
(10) Pub. No.: US 2022/0012308 A1
(43) Pub. Date: Jan. 13, 2022

(54) APPARATUS, METHOD, AND STORAGE MEDIUM

(71) Applicant: CANON KABUSHIKI KAISHA, Tokyo (JP)

(72) Inventor: Masahiko Mizoguchi, Tokyo (JP)

(21) Appl. No.: 17/361,870

(22) Filed: Jun. 29, 2021

(30) Foreign Application Priority Data
Jul. 9, 2020 (JP) 2020-118787

(51) Int. Cl. G06F 17/17; G06F 7/544; G06F 7/50; G06F 7/499

(52) U.S. Cl. CPC G06F 17/17; G06F 7/49947; G06F 7/50; G06F 7/544

(57) ABSTRACT

A data conversion method by a high-order function is implemented with a small-scale circuit. One embodiment of the present invention is an apparatus including: a determination unit configured to determine, based on input data, a first reference address indicating a plurality of interpolation ranges for calculating quadratic function coefficients and an interpolation distance including the plurality of interpolation ranges; a coefficient computation unit configured to calculate the quadratic function coefficients based on the first reference address; an adjustment unit configured to perform cut-out processing for the interpolation distance represented by bits and output cut-out data as an adjustment interpolation distance; and a computation unit configured to calculate output data by performing a quadratic interpolation computation based on the quadratic function coefficients and the adjustment interpolation distance.

### BACKGROUND OF THE INVENTION

### Field of the Invention

The present invention relates to a data processing technique to process data of an image and the like.

### Description of the Related Art

A tone conversion function to correct or convert the tone of an image, or a geometrical conversion function to correct or transform the shape of an image can be approximated by a global function or a local function that take the coordinate position of an image as a variable and many of those are expressed by a polynomial and a rational polynomial such as projection conversion. However, even in a case where it is possible to approximate them by a local function, it is difficult to appropriately determine the application area of the local function and switch the local function to another function at the area boundary.

Consequently, in data processing in which the tone correction, the shape transformation and the like are performed, generally, a value obtained by evaluating a local function value at a grid point for each certain pixel interval is stored in an LUT (lookup table) and the function value at the grid point read from the LUT is interpolated and used as a correction value or a transformation value.

It is not necessary to calculate the data stored in the LUT real time, and therefore, the data is calculated and generated with an accuracy as high as possible by using high-order polynomials and various functions that require a complicated computation. In contrast to this, it is necessary to perform the interpolation processing and the like of the data read from the LUT real time, and therefore, as described in Japanese Patent Laid-Open No. 2011-081477, generally, linear interpolation or cubic interpolation is performed. Further, Japanese Patent Laid-Open No. H09-511079 has also disclosed a technique relating to quadratic interpolation whose performance and computation scale are intermediate between the linear interpolation and the cubic interpolation described previously.

However, in a case where an attempt is made to perform interpolation with a high-order polynomial, it is necessary to perform multiplication and addition many times and in addition to this, it is necessary to calculate the coefficients of the polynomial real time, and therefore, the circuit configuration becomes a large scale. For example, in a video device, the pixel rate and the operating frequency of the computation circuit are substantially the same and in order to perform the computation for each pixel, the multipliers corresponding to the number of times of multiplication that appear in the computation formula are necessary. Particularly, in recent years, a high-resolution video, such as an 8K×4K video, appears and in the situation in which the pixel rate is higher than the operating frequency of the computation circuit, it is necessary to drive the computation circuits in parallel, and therefore, the circuit scale increases further.

Here, in order to implement data conversion by a function whose nonlinearity is strong, in other words, by a high-order function with a high accuracy by table data and interpolation processing, it becomes necessary to narrow the grid interval of the table data or to perform high-order interpolation processing. However, the narrower the grid interval, the more the memory amount increases and the higher the order of the interpolation processing, the more the computation scale increases. Consequently, there is such a problem that the circuit scale to improve the interpolation accuracy increases and the cost is raised.

Consequently, the applicant of the present application has disclosed in Japanese Patent Laid-Open No. 2020-135283 a technique relating to quadratic interpolation of an uneven grid interval, which enables implementation of data processing by a high-order function with a high accuracy and with a small amount of computation, and which enables miniaturization of the circuit scale and a reduction in cost.

Further, in recent years, an HDR (High Dynamic Range) video has also prevailed and in this case, the bit width of the data that is handled increases, and therefore, this also results in an increase in the circuit scale. Because of this, as a method of reducing the bit width of data while maintaining the High Dynamic Range, it is effective to convert data into a floating point.

However, with the technique described in Japanese Patent Laid-Open No. 2020-135283, in order to convert input data from fixed-point data into floating-point data, additional computation is necessary, and therefore, there is such a problem that the circuit scale increases.

Consequently, in view of the above-described problem, an object of one embodiment of the present invention is to implement a data conversion method by a high-order function with a small-scale circuit.

### SUMMARY OF THE INVENTION

One embodiment of the present invention is an apparatus including: a determination unit configured to determine, based on input data, a first reference address indicating a plurality of interpolation ranges for calculating quadratic function coefficients and an interpolation distance including the plurality of interpolation ranges; a coefficient computation unit configured to calculate the quadratic function coefficients based on the first reference address; an adjustment unit configured to perform cut-out processing for the interpolation distance represented by bits and output cut-out data as an adjustment interpolation distance; and a computation unit configured to calculate output data by performing a quadratic interpolation computation based on the quadratic function coefficients and the adjustment interpolation distance.

Further features of the present invention will become apparent from the following description of exemplary embodiments with reference to the attached drawings.

### BRIEF DESCRIPTION OF THE DRAWINGS

FIG. 1A and FIG. 1B are block diagrams showing a configuration of an apparatus in a first embodiment;

FIG. 2 is an explanatory diagram of quadratic interpolation processing in a case where a grid interval DIS is constant;

FIG. 3 is an explanatory diagram of quadratic interpolation processing in a case where the grid interval DIS is not constant;

FIG. 4 is a block diagram showing a detailed configuration of a coefficient computation unit in the first embodiment;

FIG. 5 is a block diagram showing a detailed configuration of a reference data updating unit in the first embodiment;

FIG. 6 is an explanatory diagram of quadratic interpolation processing in a case where the grid interval DIS is not constant;

FIG. 7 is a table of addresses, grid intervals, input coordinates, and output values of input data in the first embodiment;

FIG. 8 is a table of interpolation intervals, input data ranges, stored reference data, and updating reference data in each interpolation range in the first embodiment;

FIG. 9 is an explanatory diagram about extraction of address information on correction input data and adjustment of the interpolation distance in the first embodiment; and

FIG. 10 is a flowchart of processing performed by a data conversion apparatus in the first embodiment.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

### <Configuration of Data Processing Apparatus>

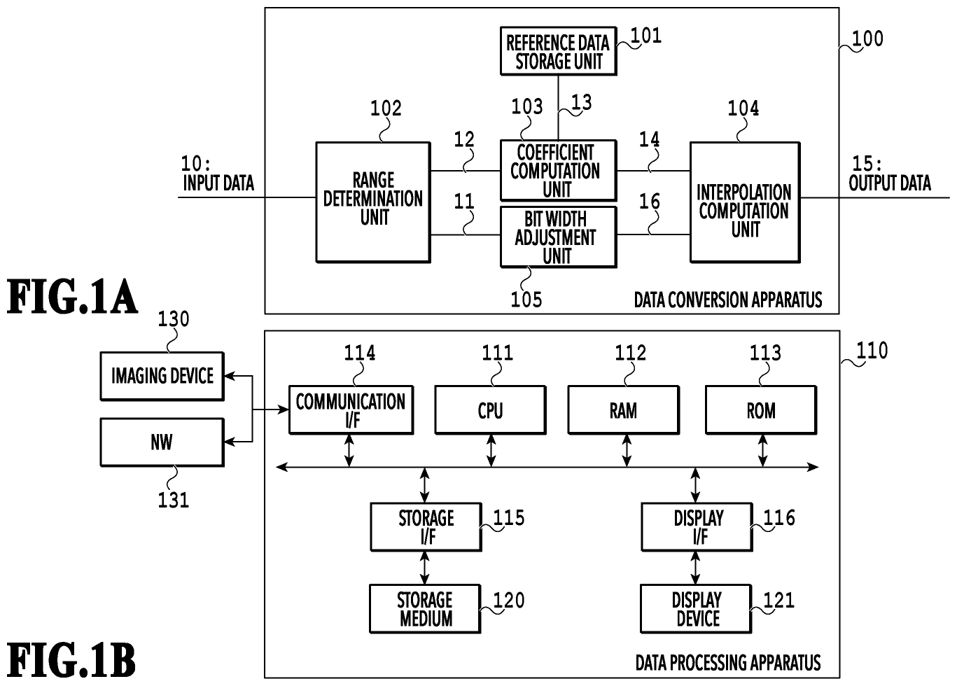

FIG. 1A and FIG. 1B are diagrams showing one configuration example of an apparatus in the present embodiment. FIG. 1A is a function block diagram showing each function unit corresponding to each piece of processing performed in a data conversion apparatus 100 in the present embodiment. FIG. 1B is a block diagram showing the hardware configuration of a data processing apparatus 110 that implements the data conversion apparatus 100 shown in FIG. 1A.

The data processing apparatus 110 is a personal computer or the like and as shown in FIG. 1B, has a CPU 111, a RAM 112, a ROM 113, a communication interface (in the following, abbreviated to I/F) 114, a storage I/F 115, and a display I/F 116. Further, the data processing apparatus 110 is connected with a storage medium 120, such as a hard disk or a semiconductor memory, via the storage I/F 115 and connected to a display device 121, such as a liquid crystal display, via the display I/F 116. Furthermore, the data processing apparatus 110 is also connected to an imaging device 130, for example, such as a camera, and various kinds of network (in the following, abbreviated to NW) 131, via the communication I/F 114. The data processing apparatus is also called an information processing apparatus.

In the ROM 113, various programs and the like including data processing programs according to the present embodiment are stored. The program stored in the ROM 113 is loaded onto the RAM 112 and executed by the CPU 111. A program is loaded onto the RAM 112 and in addition to this, the RAM 112 is used as a work area of the CPU 111 and input image data and image data and the like being processed are stored temporarily.

The communication I/F 114 performs communication, for example, between the imaging device 130 and the network 131. For example, in a case where the communication I/F 114 receives image data and the like sent from the imaging device 130 or the network 131, the image data is stored temporarily in the RAM 112 under the control of the CPU 111. Then, various kinds of image processing and the like are performed for the image data by the CPU 111 as needed. After that, based on the image data, an image is displayed on the screen of the display device 121 via the display I/F 116, the image data is stored in the storage medium 120 via the storage I/F 115, and so on.

The CPU 111 performs various kinds of processing and control in the data processing apparatus 110 and performs various kinds of image processing including data conversion processing, as will be described later, by executing the data processing programs and the like according to the present embodiment. In the present embodiment, explanation is given on the assumption that the processing of each function unit of the data conversion apparatus 100 shown in FIG. 1A is implemented by the software processing in which the CPU 111 executes the program. However, of course, it may also be possible to implement the processing of each function unit by a hardware configuration, such as a circuit corresponding to each function unit.

### <Outline of Quadratic Interpolation Processing>

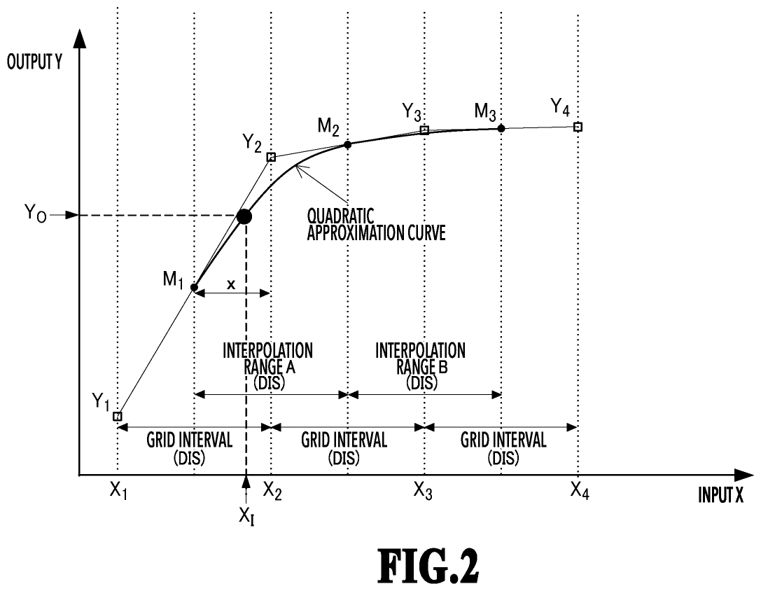

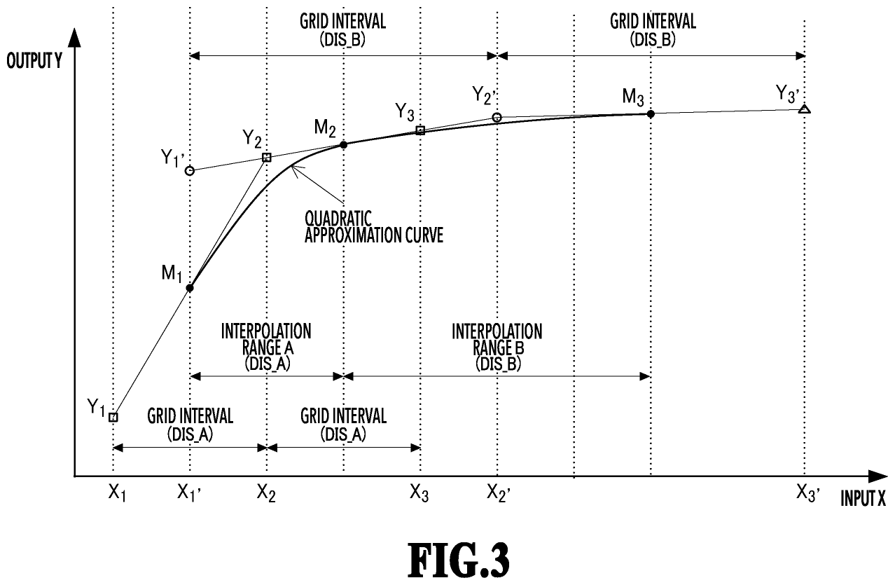

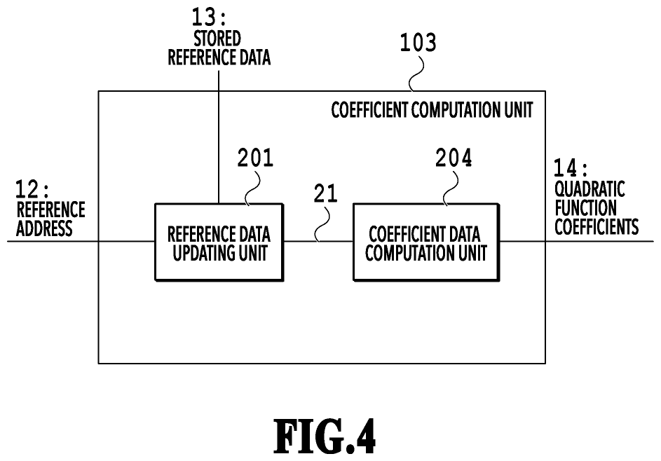

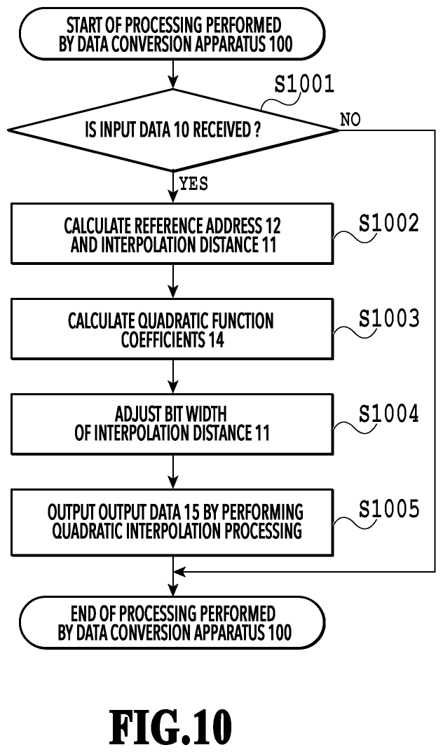

In the following, with reference to FIG. 1A, FIG. 2 to FIG. 4, and FIG. 10, the function configuration of the data conversion apparatus 100 and the theory of the quadratic interpolation processing that is the base of the data interpolation processing performed in the data conversion apparatus 100 are explained. FIG. 2 is a diagram for explaining the concept of the quadratic interpolation processing. FIG. 3 is a diagram for explaining the concept of the quadratic interpolation processing of an uneven grid interval that is adopted in the present embodiment. FIG. 4 is a block diagram showing an example of the function configuration of the coefficient computation unit in the present embodiment. FIG. 10 is a flowchart of the processing performed by the data conversion apparatus 100.

First, by using the flowchart in FIG. 10, the contents of the processing performed by the data conversion apparatus 100 are explained in order.

At step S1001, the CPU 111 determines whether input data 10 is received. In a case where determination results at this step are affirmative, the processing advance to step S1002. On the other hand, in a case where the determination results at this step are negative, the series of processing is terminated.

At step S1002, a range determination unit 102 calculates and outputs a reference address 12 and an interpolation distance 11 based on the input data 10.

At step S1003, a coefficient computation unit 103 calculates and outputs quadratic function coefficients 14 based on the reference address 12.

At step S1004, a bit width adjustment unit 105 adjusts the bit width of the interpolation distance 11 and outputs as an adjustment interpolation distance 16.

At step S1005, an interpolation computation unit 104 performs quadratic interpolation processing based on the quadratic function coefficients 14 and the adjustment interpolation distance 16 and outputs output data 15.

Next, the operation of each component is explained in detail. The data conversion apparatus 100 determines interpolation range information that is necessary to calculate the quadratic function coefficients 14 in accordance with the input data 10 in the range determination unit 102 and outputs as the reference address 12 in order to perform data interpolation processing. And even as, the range determination unit 102 outputs the interpolation distance 11 that is used for the computation in the interpolation computation unit 104, to be described later. Then, the coefficient computation unit 103 calculates the quadratic function coefficients 14.

In a case of calculating the quadratic function coefficients 14, the coefficient computation unit 103 calculates the quadratic function coefficients 14 based on an LUT, that is, data (referred to as stored reference data 13) stored within a reference value table stored in the reference data storage unit 101. The coefficient computation unit 103 first generates new reference data in a reference data updating unit 201 (see FIG. 4) based on the stored reference data 13. The reference data is discrete data at the grid point for each certain pixel interval. The generation of new reference data will be described later.

The input data 10 is image data, data of luminance of an image, coordinates and the like. The quadratic function coefficients 14 are data determined by the tone conversion function that corrects (specifically, converts) the tone of an image and the geometrical conversion function that corrects (specifically, transforms) the shape of an image. Among the reference data that includes the generated new reference data and which is output by the reference data updating unit 201, the data that is used for calculation of the quadratic function coefficients 14 is called updating reference data 21.

Here, only part of the updating reference data 21 is stored in the reference data storage unit 101 as LUT data and the LUT data is supplied to the reference data updating unit 201 as the stored reference data 13. Then, by performing computation based on the stored reference data 13, the reference data updating unit 201 generates reference data that is lacking by a method, to be described later.

Hereinafter, the interval between each discrete grid point of the updating reference data 21 is called a grid interval DIS. Details of the grid interval DIS will be described later and for example, the narrower the grid interval DIS, the higher the data conversion accuracy in interpolation processing is, but the larger the amount of table data that needs to be stored is. On the other hand, the wider the grid interval DIS, the lower the data conversion accuracy is, but the smaller the amount of table data that needs to be stored is.

FIG. 2 is a conceptual diagram of the quadratic interpolation processing and shows an example of a case where the grid interval DIS is constant. Y₁, Y₂, Y₃, and Y₄ in FIG. 2 are each the updating reference data 21. The updating reference data 21 is discrete data and the grid interval DIS of these Y₁, Y₂, Y₃, and Y₄ is a constant interval. Further, an interpolation range A and an interpolation range B are each a range from the middle point between adjacent reference data to the next middle point, and therefore, each interpolation interval in the interpolation range A and the interpolation range B matches with the grid interval DIS.

Here, for example, in a case where the input data 10 is X₁, the closest updating reference data 21 corresponding to the data X₁ is Y₂ and the two pieces (before and after Y₂) of the updating reference data 21 in the vicinity of the Y₂ as a center are Y₁ and Y₃. The interpolation range is found by the range determination unit 102 and in the example in FIG. 2, a range from a middle point M₁ between Y₁, and Y₂ to a middle point M₂ between Y₂ and Y₃ is calculated as the interpolation range A. The three pieces of the updating reference data 21 used at the time of finding this interpolation range A are Y (−1)=Y₁, Y (0)=Y₂, and Y (1)=Y₃ in order.

Further, the interpolation computation unit 104 calculates a segment, to be described later, and finds a quadratic approximation curve based on the segment and the middle points M₁, M₂, and generates interpolation output data Y₀ as the output data 15 by performing interpolation processing using the quadratic approximation curve.

The theoretical formula of the interpolation processing performed by the interpolation computation unit 104 is expressed by formula (1) to formula (4). In formula (1), x is obtained by normalizing the relative position of the input data 10 within the interpolation range with the grid interval DIS and takes a value between 0 and 1. Further, Y in formula (1) to formula (4) is the output data 15.

Y=(Ca·x+Cb)·x+Cc formula (1)

Ca=(Y(−1)−2·Y(0)+Y(1))/2 formula (2)

Cb=Y(0)−Y(1) formula (3)

Cc=(Y(1)+Y(0))/2 formula (4)

The interpolation computation unit 104 performs the quadratic interpolation computation based on the quadratic approximation curve expressed by formula (1). Here, the quadratic function coefficients 14 described previously are Ca, Cb, and Cc in formula (1) to formula (4) and the interpolation distance 11 corresponds to x in formula (1).

The quadratic approximation curve is, in the interpolation range A in FIG. 2, a curve that passes through the middle point M₁ between Y₁ and Y₂ and the middle point M₂ between Y₂ and Y₃ and which is tangent to a segment (Y₁-Y₂) connecting Y₁ and Y₂ and a segment (Y₂-Y₃) connecting Y₂ and Y₃. The quadratic approximation curve in the interpolation range B in FIG. 2 is also found as in the case of the interpolation range A described previously. The quadratic approximation curve in the interpolation range B is a curve that passes through the middle point M₂ between Y₂ and Y₃ and a middle point M₃ between Y₃ and Y₄ and which is tangent to the segment (Y₂-Y₃) connecting Y₂ and Y₃ and a segment (Y₃-Y₄) connecting Y₃ and Y₄.

That is, at the boundary portion between the interpolation range A and the interpolation range B adjacent to each other, the middle point M₂ is the same point and the segment (Y₂-Y₃) is the same segment. In other words, at the boundary portion between the interpolation range A and the interpolation range B adjacent to each other, the middle point M₂ and the segment (Y₂-Y₃) are used in common, and therefore, the quadratic approximation curves at the boundary portion between both the interpolation ranges are connected smoothly without exception. The conversion characteristic from input data into output data of this quadratic approximation curve is determined by the series of reference data stored as table data without performing the processing corresponding to the processing by the reference data generation unit described in Japanese Patent Laid-Open No. 2020-135283. Consequently, in the data conversion apparatus 100, it is possible to implement data interpolation suitable to gamma conversion that implements a conversion characteristic determined in advance, and the like.

<Outline of Quadratic Interpolation Processing in a Case where Grid Interval DIS is not Constant>

One of the characteristics of the present embodiment is that a case where each value of the grid interval in table data is not constant, that is, a case where the grid interval is uneven is taken into consideration. In the following, a case is explained where the grid interval to be applied varies depending on input data.

The uneven grid interval such as this is suitable to the tone conversion function and so on whose nonlinearity is strong. For example, by applying a narrow grid interval to a low-tone area whose nonlinearity is strong and applying a wide grid interval to a high-tone area whose linearity is strong, it is made possible to reduce the amount of table data that needs be stored while keeping high the tone conversion accuracy of the entire area from the low-tone area to the high-tone area. However, in this case, there is a possibility that a state where the grid interval and the interpolation interval are different at the boundary portion between the interpolation ranges adjacent to each other is brought about, and therefore, it becomes necessary to take steps to smoothly connect the quadratic approximation curves in both the interpolation ranges. The quadratic interpolation in a case where the grid interval is uneven in the present embodiment makes it possible to implement the smooth connection between the quadratic approximation curves in both the interpolation ranges in a case where the grid interval and the interpolation interval are different at the boundary portion between the interpolation ranges adjacent to each other.

### <Reference Data Generation>

In the reference data storage unit 101, only part of the necessary updating reference data 21 is stored as table data, and therefore, reference data that is lacking is generated in the reference data updating unit 201. Specifically, from the characteristic of the quadratic interpolation that is adopted in the present embodiment, two pieces of reference data Y_{1′} and Y_{2′} that satisfy formula (5) to formula (9) below are generated in order to smoothly connect the quadratic approximation curves at the boundary portion between different interpolation ranges, that is, at the middle point M₂ in FIG. 3.

X₂+X₃=X_{1′}+X_{2′} formula (5)

Y₂+Y₃=Y_{1′}+Y_{2′} formula (6)

Formula (5) means that the middle point in each piece of input data is the same and formula (6) means that the middle point in each piece of output data is the same. Consequently, by satisfying formula (5) and formula (6), the coordinates of the middle point M₂ that is the boundary portion between the interpolation range A and the interpolation range B are the same, and therefore, even across both the interpolation ranges, the quadratic approximation curves are connected continuously and smoothly.

(Y₃−Y₂)/(X₃−X₂)=(Y₂−Y_{1′})/(X₂−X₁) formula (7)

X₃−X₂=DIS_A formula (8)

X₂−X₁=DIS_B formula (9)

Formula (7) means that the gradient of the segment connecting reference data adjacent to each other is the same. Consequently, by satisfying formula (7), it is possible to make the same the gradients of the quadratic approximation curves at the coordinates of the middle point M₂ that is the boundary portion between the interpolation range A and the interpolation range B.

FIG. 3 is a diagram explaining the concept of the processing by the reference data updating unit 201 in the present embodiment. Of the reference data shown in FIG. 3, data Y₁, Y₂, and Y₃ indicated by □ and data Y_{3′} indicated by A are stored in the reference data storage unit 101 as table data. On the other hand, data Y_{1′}, Y_{2′} indicated by ∘ in FIG. 3 are generated by the reference data updating unit 201 in accordance with formula (10) and formula (11) that are derived from formula (5) to formula (9).

Y_{1′}=(½)·[(Y₂+Y₃)+(DIS_B/DIS_A)·(Y₃−Y₂)] formula (10)

Y₂=(½)·[(Y₂+Y₃)−(DIS_B/DIS_A)·(Y₃−Y₂)] formula (11)

In the present embodiment, by satisfying formula (10) and formula (11), it is possible to make the same the gradients of the quadratic approximation curves at the coordinates of the middle point M₂ that is the boundary portion between the interpolation range A and the interpolation range B.

As described above, in the present embodiment, it is possible to reduce the table data. It is desirable for the value of each grid interval in the explanation described previously to be a power of 2 at the time of selecting the table data and at the time of calculating the relative position x, and in order to reduce the computation load of the relational formulas of formula (10) and formula (11), but the value is not limited to this. Further, the grid interval DIS_B shown in FIG. 3 is double DIS_A, but the grid interval relationship is not limited to this and for example, the grid interval DIS_B may be three times, four times, or a half, a quarter of DIS_A and may be any positive real number multiple. Further, the example is shown in which Y_{1′} and Y_{2′} are generated based on Y₂ and Y₃ by using formula (10) and formula (11), but this is not limited and it may also be possible to generate Y₂ and Y₃ based on Y_{1′} and Y_{2′}. At that time, it may be possible to use calculation formulas obtained by solving Y₂ and Y₃ based on formula (5) to formula (9).

### <Detailed Operation of Reference Data Updating Unit>

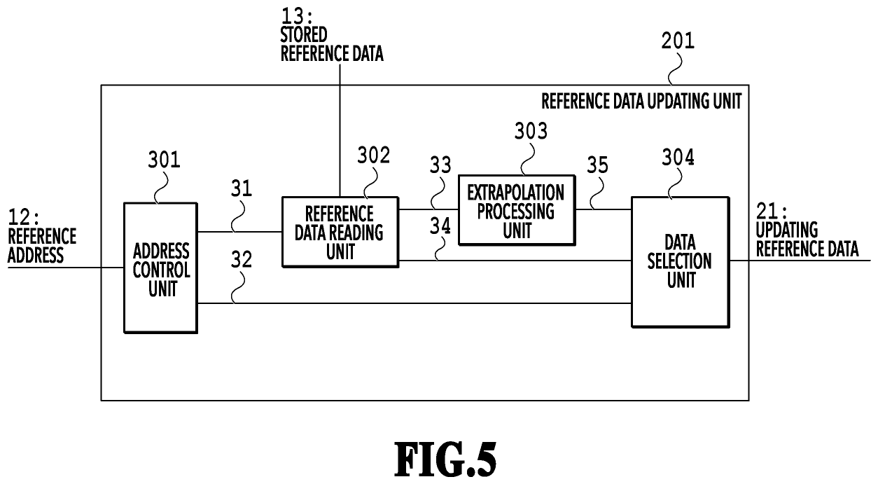

FIG. 5 is a block diagram showing a detailed configuration of the reference data updating unit 201 in the present embodiment. An address control unit 301 generates a first reference address 31 for referring to the stored reference data 13 based on information on the reference address 12. Specifically, the first reference address 31 in the present embodiment is interpolation interval information on the interpolation range in accordance with the input data 10. Further, similarly, the address control unit 301 generates a second reference address 32 based on the information on the reference address 12. Specifically, the second reference address 32 in the present embodiment is information indicating what number interpolation range in the interpolation interval information on a plurality of interpolation ranges indicated by the first reference address 31 described previously.

A reference data reading unit 302 acquires, in accordance with the first reference address 31, all the data of the relevant grid interval of the data stored in the reference data storage unit 101 and the data of the different grid interval adjacent to the data as the stored reference data 13. The reference data reading unit 302 outputs all the data of the relevant grid interval described previously as second acquired reference data 34. Further, the reference data reading unit 302 outputs the data of the different grid interval adjacent to the second acquired reference data 34 as first acquired reference data 33. The number of pieces of the data that is acquired by the reference data reading unit 302 and which has the same grid interval is a predetermined number larger than or equal to four.

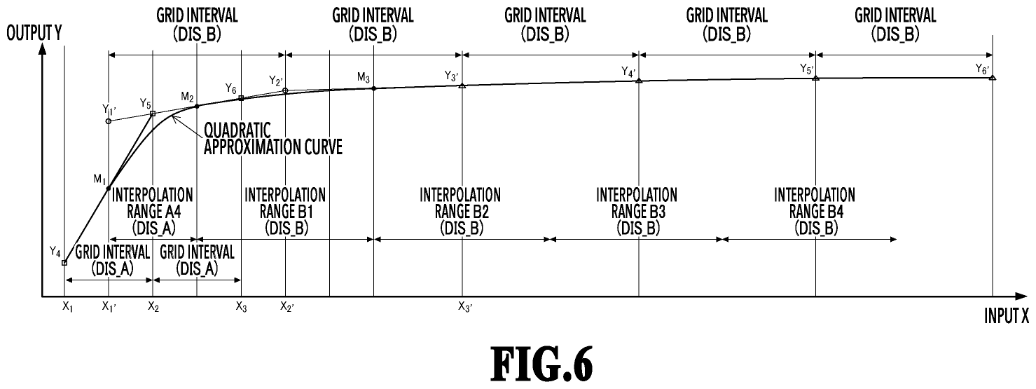

By using FIG. 6, the quadratic interpolation processing in a case where the grid interval is not constant is explained. FIG. 6 is a diagram explaining the concept of the processing in the reference data updating unit 201 in the present embodiment and an explanatory diagram of the quadratic interpolation processing in a case where the grid interval is not constant. FIG. 6 shows a case where there are four interpolation ranges having the same interpolation interval. An interpolation range B1, an interpolation range B2, an interpolation range B3, and an interpolation range B4 whose interpolation interval is the same as that of the grid interval DIS_B in FIG. 6 correspond to the four interpolation ranges. Although there are four interpolation ranges whose interpolation interval is the same as that of DIS_A, in FIG. 6, only one interpolation range A4 of them is shown schematically. In the present embodiment, the stored reference data 13 is six pieces of data, that is, Y_{3′}, Y_{4′}, Y₅, and Y_{6′} (second acquired reference data 34), and Y₅ and Y₆ (first acquired reference data 33) in FIG. 6.

An extrapolation processing unit 303 performs processing based on formula (10) and formula (11), that is, extrapolation processing and outputs two pieces of extrapolation processing data 35 of Y_{1′} and Y_{2′} by using two pieces of data (Y₅ and Y₆ in FIG. 6) of the first acquired reference data 33. Each piece of reference data in formula (10) and formula (11) is data corresponding to FIG. 3, and therefore, it is necessary to partially modify with data corresponding to FIG. 6 or replace the data to data corresponding to FIG. 6. Specifically, in a case where Y_{1′} and Y_{2′} in FIG. 6 are calculated, Y₂ in formula (10) and formula (11) is replaced with Y₅ in FIG. 6 and Y₃ in formula (10) and formula (11) is replaced with Y₆ in FIG. 6.

A data selection unit 304 selects three consecutive pieces of data from the extrapolation processing data 35 and the second acquired reference data 34 (that is, the six pieces of data Y₁, Y₂, Y_{3′}, Y_{4′}, Y₅, and Y_{6′} in FIG. 6) based on the second reference address 32 and outputs them as the updating reference data 21. At this time, which three consecutive pieces of data are selected is determined based on the interpolation range indicated by the second reference address 32 (interpolation range B1, interpolation range B2, interpolation range B3, or interpolation range B4 in FIG. 6). Consequently, for example, in a case where the second reference address 32 indicates the interpolation range B1, the updating reference data 21 is Y₁, Y₂, and Y_{3′}. Similarly, in a case where the second reference address 32 indicates the interpolation range B2, the updating reference data 21 is Y₂, Y_{3′}, and Y_{4′}. Similarly, in a case where the second reference address 32 indicates the interpolation range B3, the updating reference data 21 is Y_{3′}, Y_{4′}, and Y_{5′}. Similarly, in a case where the second reference address 32 indicates the interpolation range B4, the updating reference data 21 is Y_{4′}, Y₅, and Y_{6′}.

The coefficient data computation unit 204 calculates and outputs the quadratic function coefficients 14 (corresponding to Ca, Cb, and Cc) from the updating reference data 21 (corresponding to Y(−1), Y(0), and Y(1)) based on formula (1) to formula (4). The reference data updating unit 201 may generate the updating reference data 21 of all the interpolation ranges at the time of a computation start signal given by an upper control unit is input.

<Conversion of Input Data into Floating Point>

The present embodiment reduces the computation bit width by converting input data into a floating point and is characterized in that interpolation processing is implemented with a small-scale circuit by reducing the bit width of valid data.

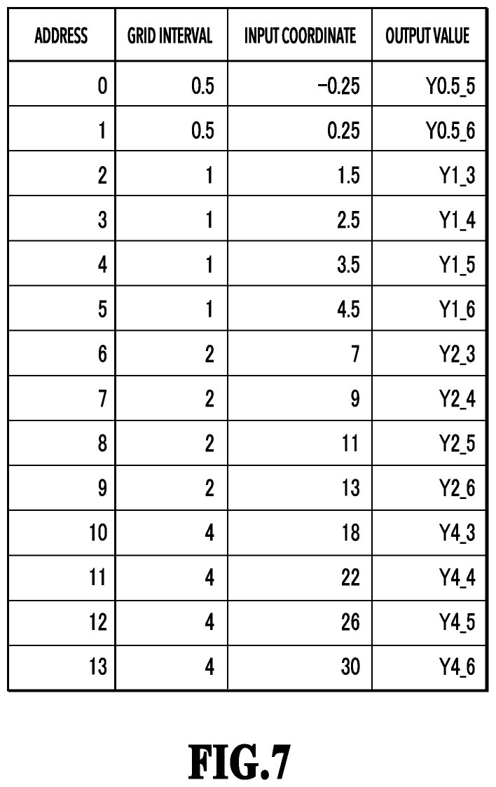

The way the reference data storage unit 101 in the present embodiment stores the table data is shown specifically, and even as, processing relating to conversion of the input data 10 into a floating point, which is performed by the range determination unit 102 and the bit width adjustment unit 105, is shown. The table data in the present embodiment is the same as the contents in FIG. 6 described previously. That is, the case is where there are four pieces of table data having the same grid interval (Y_{3′}, Y_{4′}, Y_{5′}, and Y_{6′} in FIG. 6) and four interpolation ranges having the same interpolation interval (B1, B2, B3, and B4 in FIG. 6). Further, in the present embodiment, the grid interval and the interpolation interval start from 1 and increases with powers of 2. In this case, the table data whose grid interval is 1 to 4 is as shown in FIG. 7. Here, two pieces of data whose address is 0 and 1 and whose grid interval is 0.5 are necessary to generate data whose grid interval is 1 by the extrapolation processing using these two points. The data that is generated by the extrapolation processing corresponds to Y_{1′}, Y_{2′} in FIG. 6 and corresponds to the output values in FIG. 7. The input coordinate in FIG. 7 corresponds to the horizontal axis in FIG. 6 and the output value in FIG. 7 corresponds to the vertical axis in FIG. 6. In the reference data storage unit 101, actually, only the output value column in FIG. 7 is stored. In the case of the table in FIG. 7, the reference data storage unit 101 returns four pieces of data having the same grid interval and two pieces of data to be used for extrapolation processing, corresponding to the first reference address 31 given by the reference data reading unit 302, to the reference data reading unit 302. At this time, the two pieces of data to be used for the extrapolation processing are two pieces of data at the address smaller than the smallest address of the four pieces of data having the same grid interval in FIG. 7 by one and at the address smaller than the smallest address by two.

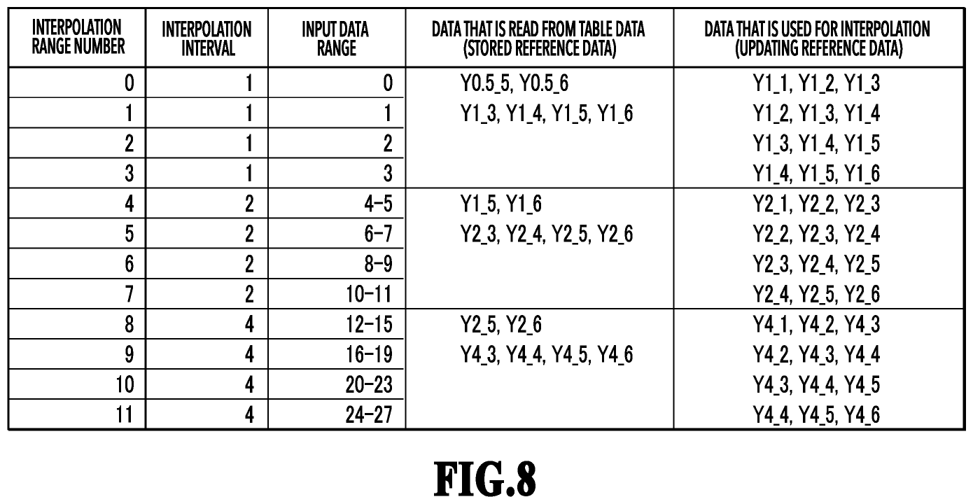

FIG. 8 shows the interpolation interval, the input data range, the data that is read from table data (stored reference data 13), and the data that is used for interpolation (updating reference data 21), in each interpolation range. In order to acquire the stored reference data 13 shown in FIG. 8, the first reference address 31 is used and in order to select the updating reference data 21 shown in FIG. 8, the second reference address 32 is used. As described previously, the first reference address 31 and the second reference address 32 are generated by the address control unit 301 based on the information on the reference address data 21 that is output by the interpolation range determination unit 102. The first reference address 31 and the second reference address 32 are calculated simply by the following procedure. Specifically, first, a fixed value is added to the input value and the correction input data is obtained. This addition value ADD_VAL is calculated based on formula (12) by an interpolation interval DIS_INI from which the quadratic interpolation calculation is started, a number NUM of pieces of data (number of grid points) having the same grid interval, and a position ADD_INI at which the input data range is 0. ADD_INI is a value indicating what number grid point at which the input data range including 0 is located of the NUM grid points having the same interval, and represented by an integer between 0 and NUM−1.

ADD_VAL=DIS_INI*NUM+ADD_INI formula (12)

DIS_INI and NUM are each limited to powers of 2 and in the present embodiment, DIS_INI=1, NUM=4. Further, ADD_INI=0, and therefore, ADD_VAL=4.

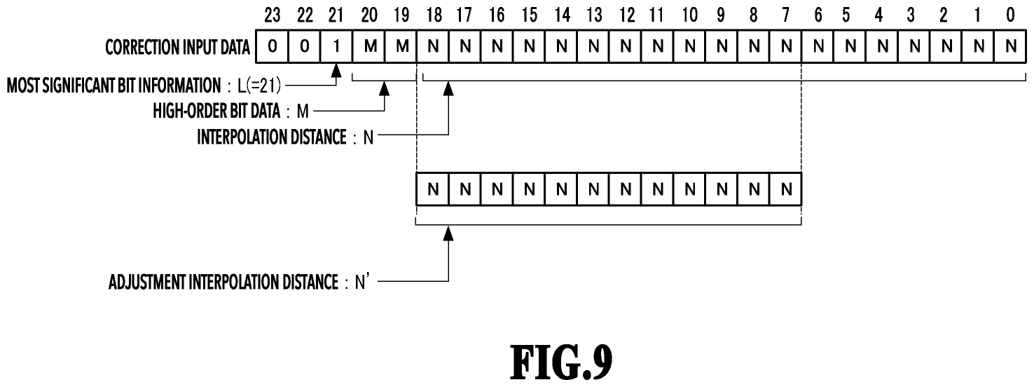

For the correction input data, address information is extracted by the concept shown in FIG. 9 and even as, the first reference address 31 and the second reference address 32 are calculated. First, the most significant bit of the correction input data is acquired. Specifically, the most significant bit of the correction input data is obtained based on the shift amount in a case where the correction input data shifts rightward until the correction input data becomes 0 and the shift amount in a case where the correction input data shifts leftward until the most significant bit becomes 1. FIG. 9 shows a case where the 21st bit of the correction input data is the most significant bit and most significant bit information L=21. The relationship between the grid interval DIS and the most significant bit information L is expressed by formula (13).

DIS=2\hat{ }(L−2) formula (13)

The first reference address 31 in the present embodiment is obtained by formula (14).

The first reference address 31=4×(L−2) formula (14)

Information on two high-order bits next to the most significant bit information L (20th bit and 19th bit in FIG. 9) is obtained as high-order bit data M. The information on these two bits becomes the second reference address 32 as it is. Further, the rest of the data (data N from 18th bit to zeroth bit in FIG. 9) becomes the interpolation distance 11. The bit width of the interpolation distance 11 changes in accordance with the value of the most significant bit information L.

As above, the calculation of the first reference address 31, the second reference address 32, and the interpolation distance 11 in the range determination unit 102 is implemented mainly by addition processing, bit shift, and processing to cut out data from a specific bit.

Reducing the bit width of the valid data and reducing the computation bit width of the interpolation computation unit 104 by converting the input data 10 into a floating point are equivalent to reducing the bit width of the interpolation distance 11. That is, in the present embodiment, it is sufficient to perform the conversion of data into a floating point for the interpolation distance 11. In general, in the process of the conversion of data into a floating point, the exponent data is acquired by the bit shift process to search for the most significant bit and the mantissa data is obtained by the process to cut out a predetermined bit width necessary for the interpolation processing from the bit-shifted data. Here, as described in the explanation of the processing of the range determination unit 102, actually, the results of completing the bit shift necessary for the conversion of data into a floating point are obtained as the interpolation distance 11. Because of that, by only the process to cut out a predetermined bit width necessary for the interpolation processing, the conversion of data into a floating point of the interpolation distance 11 is implemented.

In the present embodiment, the bit width of the interpolation distance 11 is adjusted in the bit width adjustment unit 105. Specifically, in the present embodiment, the bit width adjustment unit 105 acquires a predetermined bit width necessary for the interpolation processing from the high-order bits and outputs it as the adjustment interpolation distance 16. FIG. 9 shows an example in which the bit width adjustment unit 105 cuts out the 12 high-order bits of the interpolation distance 11. These 12 bits correspond to the bit width of the mantissa of the floating point. The bit width adjustment unit 105 also may cut out the 12 high-order bits as the adjustment interpolation distance 16 after acquiring a bit width wider than a predetermined bit width by one bit (acquiring 13 bits from the 18th bit to the sixth bit) and performing rounding up processing or rounding down processing. Further, the bit width adjustment unit 105 may cut out the 12 high-order bits after adding a 7-bit random value (data obtained by performing processing to stochastically round up or round down the data from the sixth bit to the zeroth bit) to the interpolation distance 11. In a case where the interpolation distance 11 is carried by the rounding up processing or the rounding down processing, it becomes necessary to perform again the calculation that takes the carry into consideration for the first reference address and the second reference address, respectively.

### <Effects of the Present Embodiment>

The present invention reduces the computation bit width by the conversion of input data into a floating point and is characterized in that interpolation processing is implemented with a small-scale circuit by reducing the bit width of valid data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, part of the coefficient computation unit 103 operates by a computation start signal given by an upper control unit and it is possible to reduce power by storing computation results in advance and only by referring to the data stored here while an image is being input.

According to the present invention, it is possible to implement data processing by a high-order function with a high accuracy and with a small amount of computation, and it is made possible to reduce the circuit scale.

This application claims the benefit of Japanese Patent Application No. 2020-118787, filed Jul. 9, 2020 which is hereby incorporated by reference wherein in its entirety.

What is claimed is:

1. An apparatus comprising:
a determination unit configured to determine, based on input data, a first reference address indicating a plurality of interpolation ranges for calculating quadratic function coefficients and an interpolation distance including the plurality of interpolation ranges;
a coefficient computation unit configured to calculate the quadratic function coefficients based on the first reference address;
an adjustment unit configured to perform cut-out processing for the interpolation distance represented by bits and output cut-out data as an adjustment interpolation distance; and
a computation unit configured to calculate output data by performing a quadratic interpolation computation based on the quadratic function coefficients and the adjustment interpolation distance.

2. The apparatus according to claim 1, further comprising:
a first generation unit configured to generate a second reference address and a third reference address based on the first reference address, wherein
the second reference address indicates information on intervals of the plurality of interpolation ranges and
the third reference address indicates an interpolation range for which the quadratic function coefficients are calculated of among the plurality of interpolation ranges.

3. The apparatus according to claim 2, further comprising:
a storage unit configured to store a combination of the input data and the output data corresponding to the input data as table data;
an acquisition unit configured to acquire part of the output data necessary to calculate the quadratic function coefficients in the plurality of interpolation ranges from a table storing the table data as first reference data based on the second reference address; and
a selection unit configured to select three pieces of data to be used to calculate the quadratic function coefficients in one interpolation range from the first reference data based on the third reference address.

4. The apparatus according to claim 3, further comprising:
a second generation unit configured to generate, in a case where second reference data having the same grid interval and third reference data that is data closest to the second reference data and whose grid interval is narrower than that of the second reference data are included in the first reference data, fourth reference data whose grid interval is the same as that of the second reference data from the third reference data.

5. The apparatus according to claim 4, wherein
the selection unit selects the three pieces of data from the second reference data and the fourth reference data.

6. The apparatus according to claim 5, wherein
in a case where the second reference data and the fourth reference data are included in the three pieces of data, of middle points that are obtained for each two pieces of data in proximity to each other in the three pieces of data, the middle point closer to a boundary portion between two interpolation ranges whose intervals are different is a common point in the two interpolation ranges.

7. The apparatus according to claim 6, wherein
the acquisition unit acquires a predetermined number, four or more, of pieces of the first reference data having the same grid interval from the table data and
the coefficient computation unit calculates the quadratic function coefficients of a quadratic approximation curve that passes through the two middle points and which is tangent to two segments that are obtained for each two pieces of data in proximity to each other among the three pieces of data.

8. The apparatus according to claim 4, wherein
a value obtained by dividing the grid interval of the second reference data by the grid interval of the third reference data is a power of 2.

9. The apparatus according to claim 3, wherein
the input data that is stored in the table data includes data whose grid interval is dense and data whose grid interval is sparse.

10. The apparatus according to claim 3, wherein
in a case where a computation start signal that is given by an upper control unit is input, the three pieces of data are selected in all interpolation ranges.

11. The apparatus according to claim 2, wherein
the second reference address is found by information on a most significant bit of correction input data and
the correction input data is calculated by adding, in a case where an interpolation range from which the quadratic interpolation computation is started is taken to be DIS_INI, a number of grid points at each grid interval of the same interval is taken to be NUM, and a position at which an input data range is 0 is taken to be ADD_INI, an addition value that is calculated by NUM*DIS_INI+ADD_INI to the input data.

12. The apparatus according to claim 11, wherein
the third reference address is found by information on two bits that are the next highest bit to the most significant bit in the correction input data.

13. The apparatus according to claim 1, wherein
the adjustment unit performs processing to cut out a bit width wider than the predetermined bit width by one bit and after performing rounding down processing or rounding up processing for the cut-out bit width, performs cut-out processing so that the cut-out bit width is a predetermined bit width, and takes data of the cut-out predetermined bit width as the adjustment interpolation distance.

14. A method comprising the steps of:
determining, based on input data, a first reference address indicating a plurality of interpolation ranges for calculating quadratic function coefficients and an interpolation distance including the plurality of interpolation ranges;
calculating the quadratic function coefficients based on the first reference address;
performing cut-out processing for the interpolation distance represented by bits and outputting cut-out data as an adjustment interpolation distance; and
calculating output data by performing a quadratic interpolation computation based on the quadratic function coefficients and the adjustment interpolation distance.

15. A non-transitory computer readable storage medium storing a program for causing a computer to perform a control method of an apparatus, the control method comprising the steps of:
determining, based on input data, a first reference address indicating a plurality of interpolation ranges for calculating quadratic function coefficients and an interpolation distance including the plurality of interpolation ranges;
calculating the quadratic function coefficients based on the first reference address;
performing cut-out processing for the interpolation distance represented by bits and outputting cut-out data as an adjustment interpolation distance; and
calculating output data by performing a quadratic interpolation computation based on the quadratic function coefficients and the adjustment interpolation distance.
